(19) United States
(12) Patent Application Publication
(10) Pub. No.: US 2025/0258614 A1
(43) Pub. Date: Aug. 14, 2025

(54) STORAGE CONTROLLER AND STORAGE DEVICE INCLUDING THE SAME

(71) Applicant: Samsung Electronics Co., Ltd., Suwon-si (KR)

(72) Inventors: Seung-Ho LEE, Suwon-si (KR); Yun-Ho YOUM, Suwon-si (KR); Myung-Sik CHOI, Suwon-si (KR)

(73) Assignee: Samsung Electronics Co., Ltd., Suwon-si (KR)

(21) Appl. No.: 18/789,890

(22) Filed: Jul. 31, 2024

(30) Foreign Application Priority Data
Feb. 8, 2024 (KR) 10-2024-0019839

(51) Int. Cl. G06F 3/06

(52) U.S. Cl. CPC G06F 3/0622; G06F 3/0655; G06F 3/0679

(57) ABSTRACT

A storage device according to the present disclosure includes: a volatile memory device configured to load main firmware; and a storage controller configured to receive a module loading request and a module from outside the storage device, perform a first signature verification operation verifying a first signature included in the module or a second signature verification operation verifying the first signature and a second signature included in the module based on information of signature to be verified, and load the module received from outside the storage device to the volatile memory device based on a result of performing the first signature verification operation or the second signature verification operation.

### CROSS-REFERENCE TO RELATED APPLICATION

This application claims priority to and the benefit of Korean Patent Application No. 10-2024-0019839 filed in the Korean Intellectual Property Office on Feb. 8, 2024, the entire contents of which are incorporated herein by reference.

### BACKGROUND OF THE INVENTION

The present disclosure relates to storage controllers and storage devices including the same.

A storage device is a device storing data. The storage device may operate according to a request of a host. The storage device may execute firmware to perform operations according to the request of the host. Firmware executed by the storage device may include main codes used for main operations such as a write operation, a read operation, and an erase operation, and additional codes used for a debugging operation, a test operation, and a user-specified operation. When additional codes are included in the firmware, the capacity of the firmware increases, and codes included in the firmware may be vulnerable to security.

### SUMMARY OF THE INVENTION

Some example embodiments are to provided of a storage controller that verifies and loads a module generated in the outside, and a storage device including the same.

A storage device according to some example embodiments includes: a volatile memory device configured to load main firmware; and a storage controller configured to receive a module loading request and a module from outside the storage device, perform a first signature verification operation verifying a first signature included in the module or a second signature verification operation verifying the first signature and a second signature included in the module based on information of signature to be verified, and load the module received from outside the storage device to the volatile memory device based on a result of performing the first signature verification operation or the second signature verification operation.

A storage device according to some example embodiments includes: a volatile memory device configured to load main firmware including main codes; and a storage controller configured to receive a module from outside the storage device, load the module to the volatile memory device based on a result of verifying a manufacturer signature and a user signature included in the module, and modify a code corresponding to a target address included in the module among the main codes based on operation mode information included in the module.

A storage controller according to some example embodiments includes: a first processor configured to execute main firmware; a second processor configured to verify a manufacturer signature in which module data included in an externally received module are signed with a private key of a manufacturer, and execute the module based on a result of verifying a user signature in which the module data and the manufacturer signature are signed with a private key of a user; and a symbol resolution module configured to perform a code patch operation modifying a code corresponding to a target address included in the module among main codes included in the main firmware based on the target address.

### BRIEF DESCRIPTION OF THE DRAWINGS

FIG. 1 is schematic depiction of an electron system including a storage device according to some example embodiments.

FIG. 2 is a schematic depiction a module according to some example embodiments.

FIG. 3 is a schematic depiction of operations of a storage device that verifies a module received from a host according to some example embodiments.

FIG. 4 is a schematic depiction of operations of a storage device that performs a signature verification operation based on information related to a signature to be verified.

FIG. 5 is a schematic depiction of operations of a storage device performing a module according to some example embodiments.

FIG. 6 is a schematic depiction of a module, main firmware, API access information, and API address map data according to some example embodiments.

FIG. 7 is a schematic depiction of a storage device that executes an API corresponding to a symbol code responding to a module execution request according to some example embodiments.

FIG. 8 is a schematic depiction of a storage device performing a code patch operation according to some example embodiments.

FIG. 9 is a schematic depiction of a storage device storing patch data to a non-volatile memory device according to some example embodiments.

FIG. 10 is a schematic depiction of a storage device that transmits an interrupt signal during operation of a code patch operation according to some example embodiments.

FIG. 11 is a flowchart for description of a storage device that performs a signature verification operation based on information related to a signature to be verified according to some example embodiments.

FIG. 12 is a flowchart for description of a storage device performing a code patch operation according to some example embodiments.

FIG. 13 is a schematic depiction of a configuration of a storage controller according to some example embodiments.

FIG. 14 is a schematic depiction of a configuration of a non-volatile memory device according to some example embodiments.

### DETAILED DESCRIPTION

Hereinafter, with reference to the accompanying drawing, some example embodiments of the present disclosure will be described in detail such that a person of an ordinary skill can easily practice it in the technical field to which the present disclosure belongs. The present disclosure may be implemented in several different forms and is not limited to the example embodiments described herein.

In order to clearly describe the present disclosure, parts without explanation or relationship are omitted, and the same reference sign is used for identical or similar components throughout the specification.

In addition, unless explicitly described to the contrary, the word “comprise”, and variations such as “comprises” or “comprising”, will be understood to imply the inclusion of stated elements but not the exclusion of any other elements.

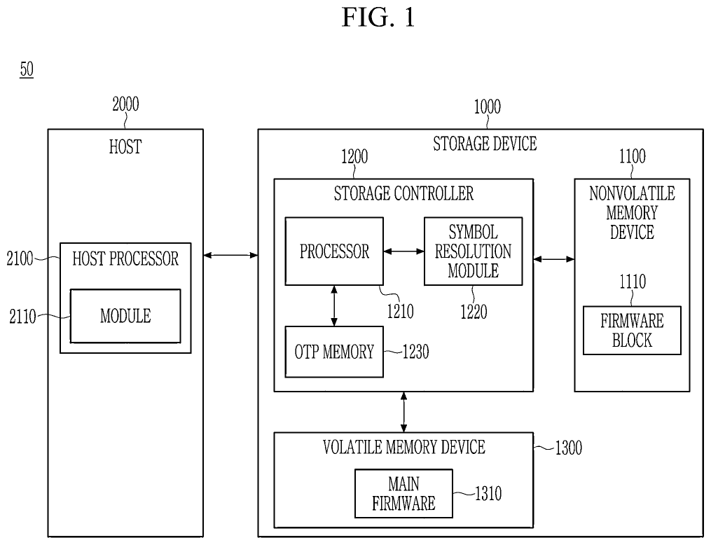

FIG. 1 is provided for description of an electron system including a storage device according to some example embodiments.

Referring to FIG. 1, an electron system 50 may include a storage device 1000 and a host 2000.

The host 2000 may include a host processor 2100. The host processor 2100 may control the overall operation of the host 2000. In some example embodiments, the host processor 2100 may generate a module 2110. The host processor 2100 may transmit the module 2110 to the storage device 1000.

In some example embodiments, the module 2110 may include codes used in a debugging operation to correct errors occurred in the storage device 1000. In some example embodiments, the module 2110 may include codes used in a test operation to test the storage device 1000. In some example embodiments, the module 2110 may include codes used to perform operations designated by a user using the storage device 1000.

In some example embodiments, the module 2110 may include a manufacturer signature and a first user signature. The manufacturer signature may be data which is included in the module and encrypted by the manufacturer of the storage device 1000 with a private key of the manufacturer. The manufacturer's signature may be decoded using a public key of the manufacturer. The first user signature may be data which is the data and the manufacturer signature included in the module and encrypted by the user of the storage device 1000 with a private key of the user. The first user signature may be decoded using the user's private key. In some example embodiments, the user may include a customer purchasing the storage device 1000.

The storage device 1000 may include a non-volatile memory device 1100, a storage controller 1200, and a volatile memory device 1300.

The non-volatile memory device 1100 may store data. The non-volatile memory device 1100 may operate in response to control of the storage controller 1200. In some example embodiments, the non-volatile memory device 1100 may be a NAND flash memory.

The non-volatile memory device 1100 may receive a command and an address from the storage controller 1200, and may perform an operation instructed by the command with respect to an area selected by the address. The non-volatile memory device 1100 may perform a program operation (write operation) to store data in the area selected by the address, a read operation to read data, or an erase operation to delete data.

In some example embodiments, the non-volatile memory device 1100 may include a firmware block 1110. The firmware block 1110 may store main firmware used in the operation of the storage device 1000.

The storage controller 1200 may control the overall operation of the storage device 1000.

In some example embodiments, when power is applied to the storage device 1000, the storage controller 1200 may load the main firmware stored in the firmware block 1110 into the volatile memory device 1300 and execute the loaded main firmware 1310.

In some example embodiments, the main firmware 1310 may include a host interface layer that controls communication between the host 2000 and the storage controller 1200, a flash conversion layer that controls communication between the host 2000 and the non-volatile memory device 1100, and a memory interface layer that controls communication between the storage controller 1200 and the non-volatile memory device 1100.

In some example embodiments, the storage controller 1200 may control the non-volatile memory device 1100 to perform a write operation, a read operation, or an erase operation according to a request from the host 2000. The storage controller 1200 may provide a write command, an address, and data to the non-volatile memory device 1100 during the write operation. The storage controller 1200 may provide a read command and an address to the non-volatile memory device 1100 during the read operation. The storage controller 1200 may provide an erase command and an address to the non-volatile memory device 1100 during the erase operation.

In some example embodiments, the storage controller 1200 may include a processor 1210, a symbol resolution module 1220, and a one-time programmable (OTP) memory 1230.

The processor 1210 may control the entire operation of the storage controller 1200. In some example embodiments, the processor 1210 may control to load the main firmware stored in the firmware block 1110 to the volatile memory device 1310.

The processor 1210 may execute the main firmware 1310. In some example embodiments, the main firmware 1310 may include a plurality of application programming interfaces (API). Each of the plurality of APIs may include a plurality of main codes. In some example embodiments, the processor 1210 may execute the main firmware 1310 to control the non-volatile memory device 1100 to perform the write operation, the read operation, and/or the erase operation.

In some example embodiments, the processor 1210 may receive the module 2110 from the host 2000 and verify the manufacturer signature and the first user signature included in the module 2110.

In some example embodiments, the processor 1210 may perform a first signature verification operation to verify the manufacturer signature or a second signature verification operation to verify the manufacturer signature and the first user signature based on information related to the signature to be verified stored in the OTP memory 1230. Information of the signature to be verified may include first verification target information corresponding to the first signature verification operation or second verification target information corresponding to the second signature verification operation.

In some example embodiments, the processor 1210 may control the module 2110 received from the host 2000 to the volatile memory device 1300 based on a result of performing the first signature verification operation or the second signature verification operation.

In some example embodiments, the processor 1210 may execute the module loaded to the volatile memory device 1300. The processor 1210 may transmit an API request requesting an API corresponding to a symbol code to the symbol resolution module 1220 in response to the execution of the symbol code among a plurality of module codes included in the module 2110. In some example embodiments, the symbol code may be a code that requests execution of an API included in main firmware 1310.

In some example embodiments, the symbol resolution module 1220 may generate API access information indicating whether access to the APIs included in the main firmware 1310 is allowed based on API information included in the module 2110. The API access information may be stored in the volatile memory device 1300.

In some example embodiments, the symbol resolution module 1220 may obtain an API corresponding to the symbol code included in the module 2110 among the APIs included in the main firmware 1310 based on the API access information.

In some example embodiments, the symbol resolution module 1220 may execute an API that corresponds to the symbol code based on the API access information. In some example embodiments, the symbol resolution module 1220 may not execute the API corresponding to the symbol code when the API access information includes prohibition information that prohibits execution of the API corresponding to the symbol code. In some example embodiments, the symbol resolution module 1220 may provide the processor 1210 with a result of execution of the API corresponding to the symbol code when the API access information includes permission information allowing the execution of the API corresponding to the symbol code.

In some example embodiments, the symbol resolution module 1220 may perform a code patch operation to modify a code corresponding to a target address included in the module 2110 among the plurality of main codes included in the main firmware 1310 based on the operation mode information included in module 2110. In some example embodiments, the symbol resolution module 1220 may modify the code corresponding to the target address included in the module 2110 into a code that executes a patch code included in the module 2110 when the operation mode information included in the module 2110 includes patch operation mode information.

In some example embodiments, after the code patch operation is performed, the processor 1210 may execute the patch code included in the module 2110 according to the code corresponding to the target address.

The OTP memory 1230 may store information related to a signature to be verified. Information of the signature to be verified may include first verification target information corresponding to the first signature verification operation or second verification target information corresponding to the second signature verification operation.

In some example embodiments, the OTP memory 1230 may store information of the signature to be verified, including first verification target information. The information of the signature to be verified may be updated from the first verification target information to the second verification target information according to a verification information update request received from the host 2000. In some example embodiments, the information of the signature to be verified stored in the OTP memory 1230 may be updated by the processor 1210.

The volatile memory device 1300 may temporarily store data provided from the host 2000 or data read from the non-volatile memory device 1100. In some example embodiments, the volatile memory device 1300 may be a dynamic random access memory (DRAM) or a static random access memory (SRAM). In some example embodiments, the volatile memory device 1300 may be disposed outside the storage controller 1200, or may be disposed inside the storage controller 1200.

In some example embodiments, the volatile memory device 1300 may store the main firmware 1310 read from the firmware block 1110 of the non-volatile memory device 1100. In some example embodiments, the main firmware 1310 may include a private key and a public key of the manufacturer of the storage device 1000.

In some example embodiments, the volatile memory device 1300 may store the module 2110 received from the host 2000. In some example embodiments, the volatile memory device 1300 may store API access information indicating whether access to APIs included in the main firmware 1310 is allowed. In some example embodiments, the volatile memory device 1300 may store API address map data indicating positions where the APIs included in the main firmware 1310 are stored.

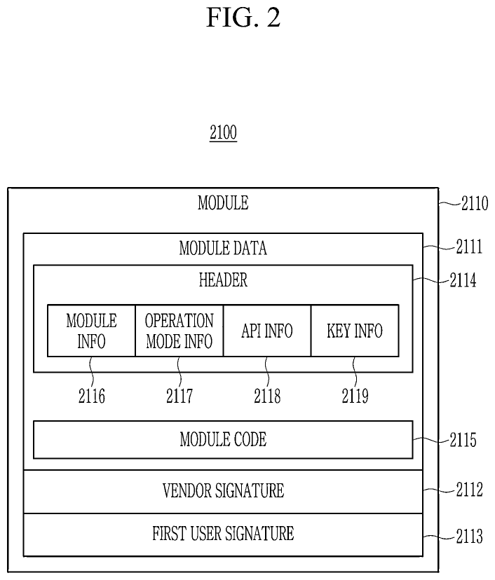

FIG. 2 is provided for description of a module according to some example embodiments.

Referring to FIG. 2, the host processor 2100 may generate the module 2110.

In some example embodiments, the host processor 2100 may generate module data 2111 including a header 2114 and a module code 2115. The header 2114 may include module information 2116, operation mode information 2117, API information 2118, and key information 2119. The module information 2116 may include information about a module ID, a module version, and/or a module creation date.

The operation mode information 2117 may include information on a mode in which the module is executed. In some example embodiments, the operation mode information 2117 may include one-time mode information, session mode information, or patch mode information. The one-time mode information may be information indicating a mode in which the module is executed once and the module is not additionally executed. The session mode information may be information indicating a mode in which execution of a module is terminated according to a command from the host 2000. The patch mode information may be information indicating a mode for modifying the main code included in the main firmware 1310.

The API information 2118 may include information about APIs that the module can execute among the APIs included in the main firmware 1310.

The key information 2119 may include information on keys used in execution of the module. In some example embodiments, the key information may include a user public key and an encryption key. The encryption key may be used to encrypt or decode a module code.

In some example embodiments, the module code 2115 may include codes used for the debugging operation. The module code 2115 may include codes used for the test operation. The module code 2115 may include codes used for performing a user-specified operation. In some example embodiments, module code 2115 may include information about an address indicating a position at which a code will be loaded into the volatile memory device 1300.

In some example embodiments, the module code 2115 may be a code encrypted using the encryption key. In some example embodiments, the host processor 2100 may generate an encryption key by encrypting the decryption key with the public key of the manufacturer. In some example embodiments, the decryption key may be a key generated based on the module information. The host processor 2100 may generate a module code that encrypts the code with the encryption key.

In some example embodiments, the host processor 2100 may generate a manufacturer (e.g. vendor) signature 2112 by signing the module data 2111 including the header 2114 and module code 2115 with a private key of the manufacturer. The manufacturer signature 2112 may be data, which is the module data encrypted with the manufacturer's private key. In some example embodiments, the manufacturer signature 2112 may be data obtained by encrypting a hash value obtained by hashing the module data 2111 with the manufacturer's private key.

In some example embodiments, the host processor 2100 may generate a first user signature 2113 by signing the module data 2111 and the manufacturer signature 2112 with a private key of the user. The first user signature 2113 may be data, which is the module data 2111 and the manufacturer signature 2112 encrypted with the user's private key. In some example embodiments, first user signature 2113 may be data obtained by encrypting a hash value obtained by hashing the module data 2111 and the manufacturer signature 2112 with the user's private key.

In some example embodiments, the host processor 2100 may generate the module data 2111 including the header 2114 and the module code 2115, the manufacturer signature 2112, and the first user signature 2113. The host processor 2100 may generate a module 2110 including the module data 2111, the manufacturer signature 2112, and the first user signature 2113, and provide the module 2110 to the storage device 1000.

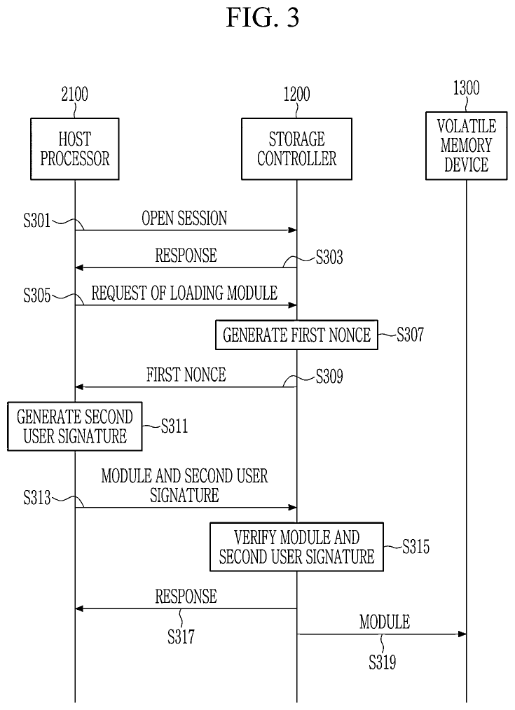

FIG. 3 is provided for description of a storage device that verifies a module received from a host according to some example embodiments.

Referring to FIG. 3, in S301, the host processor 2100 may transmit an open session command to the storage controller 1200. The storage controller 1200 may check whether the storage device 1000 is in a state capable of executing a module to be received from the host processor 2100 in response to the open session. In some example embodiments, the storage controller 1200 may check whether the storage device 1000 is in an idle state without performing an operation.

In S303, the storage controller 1200 may transmit a response indicating that the module can be executed to the host processor 2100. In some example embodiments, the storage controller 1200 may transmit a response indicating that the module can be executed when the storage device 1000 is in an idle state to the host processor 2100.

In S305, the host processor 2100 may transmit a module loading request requesting loading a module to the storage controller 1200.

In S307, the storage controller 1200 may generate a first nonce in response to the module loading request. In some example embodiments, the first nonce may be data representing a value randomly generated by the storage controller 1200 in response to the module loading request.

In S309, the storage controller 1200 may transmit the first nonce to the host processor 2100.

In S311, the host processor 2100 may generate a second user signature by signing the first nonce with a private key of a user. In some example embodiments, the second user signature may be data encrypted with the first nonce using the user's private key. In some example embodiments, the second user signature may be data obtained by encrypting a hash value obtained by hashing the first nonce with the user's private key.

In S313, the host processor 2100 may transmit the module and the second user signature to the storage controller 1200.

In S315, the storage controller 1200 may verify the module and the second user signature. In some example embodiments, the storage controller 1200 may obtain a second nonce by decoding the second user signature with the user's public key included in the module when verifying the second user signature. The storage controller 1200 may verify the reliability of the second user signature based on a result of comparing the first nonce and the second nonce.

In some example embodiments, verification of the second user signature may fail if the first nonce and the second nonce are not the same. When the verification of the second user signature fails, the storage controller 1200 may transmit a response indicating that the module loading request has failed to the host processor 2100.

In some example embodiments, if the first nonce and the second nonce are the same, verification of the second user signature may be passed. In some example embodiments, the storage controller 1200 may verify the manufacturer signature and first user signature included in the module if verification of the second user signature passes.

In some example embodiments, the storage controller 1200 may verify the reliability of the manufacturer signature based on the result of comparing the module data included in the module with data obtained by decoding the manufacturer signature included in the module with the manufacturer's public key.

In some example embodiments, when verifying the manufacturer signature, the storage controller 1200 may compare a hash value obtained by decoding the manufacturer signature with the manufacturer public key and a hash value obtained by hashing the module data.

In some example embodiments, when the hash value obtained by decoding the manufacturer signature with the manufacturer's public key and the hash value obtained by hashing the module data are not the same, verification of the manufacturer signature may fail. When the verification of the manufacturer signature fails, the storage controller 1200 may identify that the module received from host 2000 is a module that has not been approved by the manufacturer of the storage device 1000. When the verification of the manufacturer signature fails, the storage controller 1200 may transmit a response indicating that the verification of the module failed to the host processor 2100.

In some example embodiments, when the hash value obtained by decoding the manufacturer signature with the manufacturer's public key and the hash value obtained by hashing the module data are the same, verification of the manufacturer signature can be passed. When the verification of the manufacturer signature passes, the storage controller 1200 may identify that the module received from the host 2000 is a module approved by the manufacturer of the storage device 1000.

In some example embodiments, the storage controller 1200 verifies the reliability of the first user signature based on the result of comparing the data obtained by decoding the first user signature included in the module with the user's public key included in the module and the module data and the manufacturer signature included in the module.

In some example embodiments, when verifying the first user signature, the storage controller 1200 may compare the hash value obtained by decoding the first user signature with the user's public key and the hash value obtained by hashing the module data and the manufacturer signature.

In some example embodiments, when the hash value obtained by decoding the first user signature with the user's public key and the hash value obtained by hashing the module data and the manufacturer signature are not the same, verification of the first user signature may fail. In some example embodiments, when verification of the first user signature fails, the storage controller 1200 may identify that the module received from the host 2000 is a module that has not been approved by the user using the storage device 1000. When the verification of the first user signature fails, the storage controller 1200 may transmit a response indicating that verification of the module failed to the host processor 2100.

In some example embodiments, when the hash value obtained by decoding the first user signature with the user's public key and the hash value obtained by hashing the module data and the manufacturer signature are the same, verification of the first user signature may be passed. When the verification of the first user signature passes, the storage controller 1200 may identify that the module received from the host 2000 is a module approved by the user using the storage device 1000.

In S317, the storage controller 1200 may transmit a response indicating the result of verification of the module and the second user signature to the host processor 2100. In some example embodiments, the storage controller 1200 may transmit a response indicating that verification of the module and the second user signature passed or failed to the host processor 2100.

In S319, the storage controller 1200 may transmit the module to the volatile memory device 1300. The storage controller 1200 may control loading of the module received from the host 2000 into the volatile memory device 1300 when verification of the second user signature and the manufacturer signature and the first user signature included in the module passes.

In some example embodiments, the storage controller 1200 may decode a module code using an encryption key included in the module when the module code included in the module is an encrypted code. Specifically, the storage controller 1200 may obtain a decryption key by decoding the encryption key included in the module with the manufacturer's private key. The storage controller 1200 may control the module code included in the module to be decoded using a decryption key and the decoded code to be loaded into the volatile memory device 1300.

In some example embodiments, a module may include codes used for additional operations of the storage device, such as a debugging operation, a test operation, or a user-specified operation. The main firmware includes codes used for an essential operation of the storage device, such as a write operation, a read operation, and an erase operation, and codes used for additional operations may be excluded. The codes used for the additional operations are included in a separate module rather than the main firmware such that the capacity of the main firmware may be reduced.

In some example embodiments, the storage device 1000 may verify the manufacturer signature and the first user signature included in the module received from the host 2000 and load the module of which the reliability has been verified into the volatile memory device 1300. When the additional operations are required, the storage device 1000 may improve the operational performance of the storage device 1000 by loading a module including a code used for the additional operation into the volatile memory device 1300.

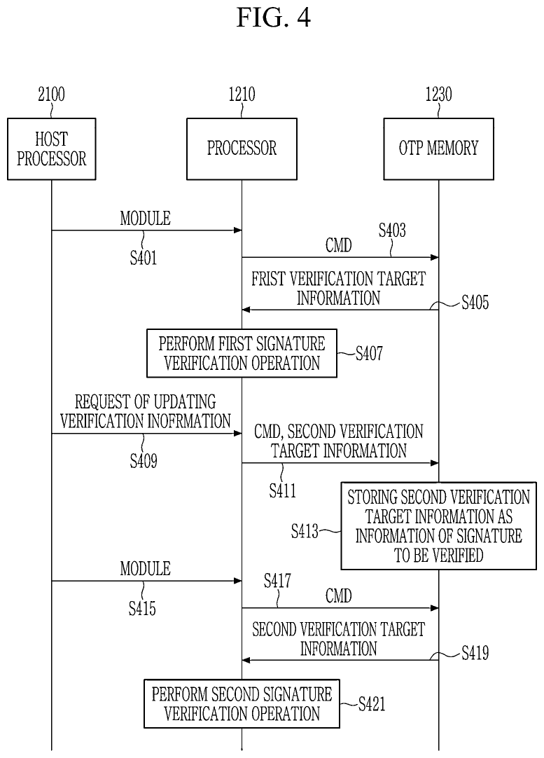

FIG. 4 is provided for description of the storage device that performs a signature verification operation based on information related to a signature to be verified.

FIG. 4 may be provided for description of S315 of FIG. 3 in detail. Referring to FIG. 4, in S401, the host processor 2100 may transmit a module to the processor 1210.

In S403, the processor 1210 may transmit a command CMD to the OTP memory 1230 to read information related to a signature to be verified. The information of the signature to be verified stored in the OTP memory 1230 may include first verification target information.

In S405, the OTP memory 1230 may transmit first verification target information to the processor 1210 as information of the signature to be verified.

In S407, the processor 1210 may perform a first signature verification operation to verify the manufacturer signature included in the module based on first verification target information. When the first signature verification operation passes, the processor 1210 may control loading of the module received from the host processor 2100 into the volatile memory device 1300.

In S409, the host processor 2100 may transmit a verification information update request to the processor 1210.

In S411, the processor 1210 may transmit a command CMD for updating information of the signature to be verified and second verification target information to the OTP memory 1230 in response to the verification information update request.

In S413, the OTP memory 1230 may respond to a command CMD received from the processor 1210 and store second verification target information as information related to the signature to be verified. The information related to the signature to be verified stored in the OTP memory 1230 may be updated from the first verification target information to the second verification target information.

In S415, the host processor 2100 may transmit a module to the processor 1210.

In S417, the processor 1210 may transmit a command CMD to the OTP memory 1230 to read information related to the signature to be verified.

In S419, the OTP memory 1230 may transmit the second verification target information to the processor 1210 as information of the signature to be verified.

In S421, the processor 1210 may perform a second signature verification operation to verify the manufacturer signature and the first user signature included in the module based on the second verification target information. The processor 1210 may control loading of the module received from the host processor 2100 into the volatile memory device 1300 based on a result of performing the second signature verification operation.

In some example embodiments, the storage device 1000 may receive a module from the host 2000, and may perform the first signature verification operation for verifying the manufacturer signature included in the module or the second signature verification operation for verifying the manufacturer signature and the first user signature included in the module based on the information of the signature to be verified, stored in the OTP memory 1230. The information of the signature to be verified may include the first verification target information corresponding to the first signature verification operation or the second verification target information corresponding to the second signature verification operation.

The storage device 1000 may load the module received from the host 2000 to the volatile memory device 1300 based on a result of performing the first signature verification operation or the second signature verification operation.

In some example embodiments, the storage device 1000 may update information of the signature to be verified stored in the OTP memory 1230 from the first verification target information to the second verification target information in response to a verification information update request received from the host 2000. In some example embodiments, the storage device 1000 may receive the verification information update request at a time that the storage device 1000 is produced.

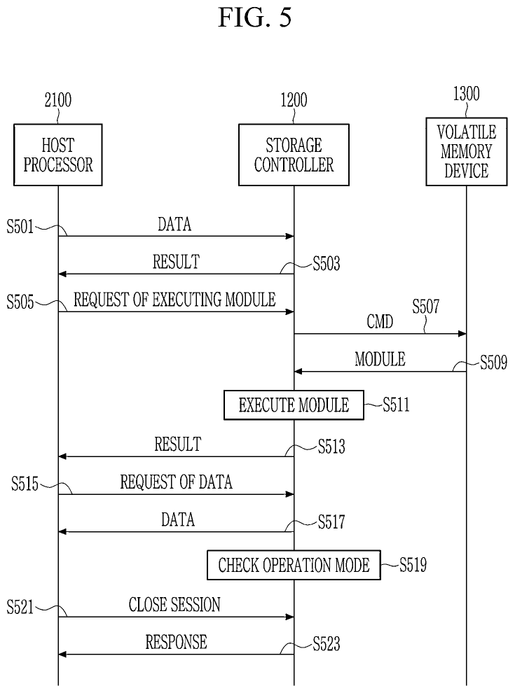

FIG. 5 is provided for description of the storage device performing a module according to some example embodiments.

Referring to FIG. 5, in S501, the host processor 2100 may transmit data to the storage controller 1200.

In S503, the storage controller 1200 may transmit a response for the receiving of the data to the host processor 2100.

In S505, the host processor 2100 may transmit a module execution request requesting execution of a module loaded in the volatile memory device 1300 to the storage controller 1200.

In S507, the processor 1210 may transmit a command CMD to the volatile memory device 1300 to read the module loaded in the volatile memory device 1300 in response to the module execution request.

In S509, the volatile memory device 1300 may transmit a module to the storage controller 1200.

In S511, the storage controller 1200 may execute the module. In some example embodiments, the storage controller 1200 may sequentially execute module codes included in the module.

In S513, the storage controller 1200 may transmit a result of executing the module to the host processor 2100.

In S515, the host processor 2100 may transmit a data request requesting data included in the module to the storage controller 1200.

In S517, the storage controller 1200 may transmit the requested data among the data included in the module to the host processor 2100 in response to the data request.

In S519, the storage controller 1200 may check operation mode information included in the module. The operation mode information may include one-time mode information, session mode information, or patch mode information.

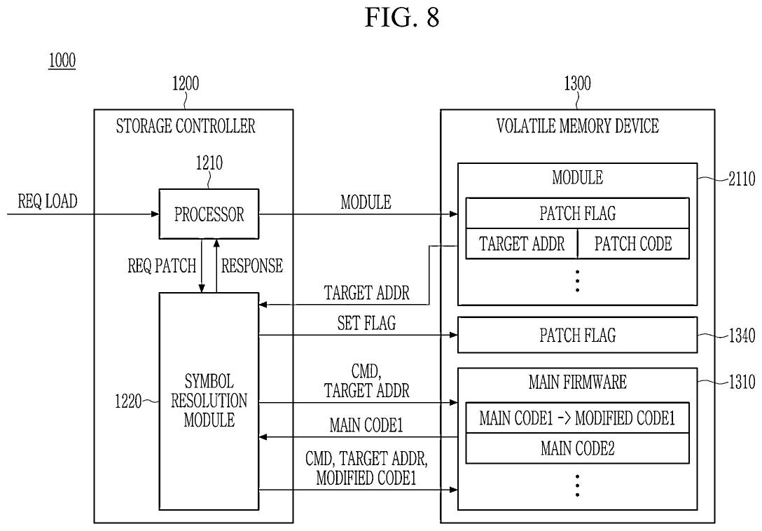

In some example embodiments, the storage controller 1200 may terminate execution of the module without receiving a close session from the host processor 2100 when the operation mode information included in the module includes one-time mode information. In some example embodiments, the storage controller 1200 may terminate execution of the module upon receiving of a close session from the host processor 2100 when the operation mode information included in the module includes session mode information. The case that the operation mode information included in the module includes patch mode information will be described later with reference to FIG. 8.

In S521, the host processor 2100 may transmit a command of the close session to the storage controller 1200. The storage controller 1200 may terminate execution of the module responding to the close session.

In S523, the storage controller 1200 may transmit a response indicating that execution of the module has ended to the host processor 2100.

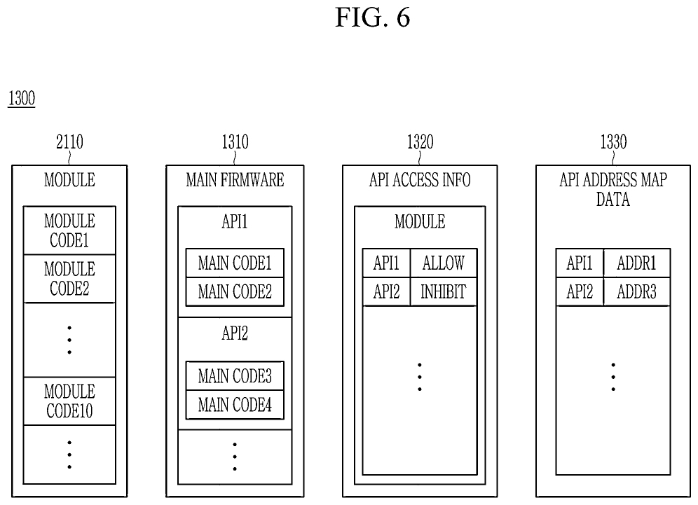

FIG. 6 is provided for description of a module, main firmware, API access information, and API address map data according to an embodiment.

Referring to FIG. 6, the volatile memory device 1300 may include a module 2110, main firmware 1310, API access information 1320, and API address map data 1330.

The module 2110 may be loaded into the volatile memory device 1300 based on a result of verifying the manufacturer signature and the first user signature included in the module 2110. The module 2110 loaded into the volatile memory device 1300 may be executed by the storage controller 1200.

In some example embodiments, the module 2110 may include a plurality of module codes. In some example embodiments, the module 2110 may include a first module code MODULE CODE1 to a tenth module code MODULE CODE10. However, the example embodiments are not so limited thereto and the module 2110 may include a first module code MODULE CODE1 to an nth module code, n being a natural number greater than 1. In some example embodiments, the first module code MODULE CODE to the tenth module code MODULE CODE10 may be codes used for debugging or test operations of the storage device 1000, or operations specified by the user using the storage device 1000.

In some example embodiments, the main firmware 1310 may include codes used in the main operation of the storage device 1000. In some example embodiments, the main operation may include a write operation, a read operation, and/or an erase operation. The main firmware 1310 loaded into the volatile memory device 1300 may be executed by the storage controller 1200.

In some example embodiments, the main firmware 1310 may include a plurality of APIs. Each of the plurality of APIs may include a plurality of main codes. In some example embodiments, the main firmware 1310 may include a first API API1 and a second API API2. In some example embodiments, the first API API1 may include a first main code MAIN CODE1 and a second main code MAIN CODE2. In some example embodiments, the second API API2 may include a third main code MAIN CODE3 and a fourth main code MAIN CODE4.

The API access information 1320 may be information indicating whether access to APIs included in main firmware 1310 is permitted. In some example embodiments, the symbol resolution module 1220 may generate API access information 1320 based on the API information included in the module 2110.

In some example embodiments, the API access information may include access allowance information ALLOW that allows execution of a corresponding API or access prohibition information INHIBIT that prohibits execution of the corresponding API. Execution of the API corresponding to the access allowance information ALLOW may be permitted. Execution of the API corresponding to the access prohibition information INHIBIT may be prohibited.

In some example embodiments, access information of the first API API1 may include the access allowance information ALLOW. In some example embodiments, the storage controller 1200 may execute the first API API1 according to the access allowance information ALLOW included in the access information of the first API while executing the module 2110.

In some example embodiments, access information of the second API API2 may include the access prohibition information INHIBIT. In some example embodiments, the storage controller 1200 may prohibit execution of the second API API2 according to the access prohibition information INHIBIT included in the access information of the second API while executing the module 2110.

The API address map data 1330 may be data indicating addresses where APIs included in the main firmware 1310 are stored. In some example embodiments, an address of the first API may be a first address ADDR1. The first API AP1 may be stored in a position corresponding to the first address ADDR1 within the volatile memory device. In some example embodiments, an address of the second API API2 may be a third address ADDR3. The second API may be stored in a position corresponding to the third address ADDR3 within the volatile memory device. In some example embodiments, the storage controller 1200 may acquire APIs included in the main firmware 1310 based on the API address map data.

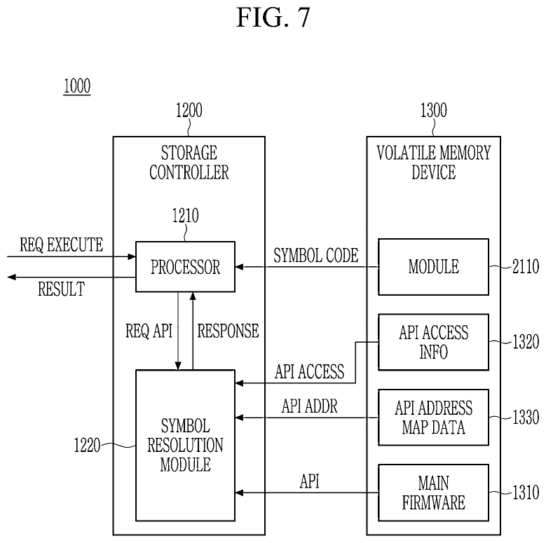

FIG. 7 is provided for description of a storage device that executes an API corresponding to a symbol code responding to a module execution request according to some example embodiments.

FIG. 7 will be described with reference to FIG. 6. Referring to FIG. 7, the storage device 1000 may include a storage controller 1200 and a volatile memory device 1300. The storage controller 1200 may include a processor 1210 and a symbol resolution module 1220. The volatile memory device 1300 may include a module 2110, main firmware 1310, API access information 1320, and API address map data 1330.

In some example embodiments, the processor 1210 may control loading of the module 2110 into the volatile memory device 1300 based on a result of verifying the manufacturer signature and the first user signature included in the module 2110 received from the host 2000. The symbol resolution module 1210 generates API access information 1320 indicating whether access to APIs included in the main firmware 1310 is allowed based on API information included in the module 2110, and stores the API access information 1320 in the volatile memory device 1300.

In some example embodiments, the processor 1210 may receive a module execution request REQ EXECUTE from the host 2000 requesting execution of the module 2110 loaded in the volatile memory device 1300. The processor 1210 may execute the module 2110 loaded on the volatile memory device 1300 in response to the module execution request REQ EXECUTE.

In some example embodiments, the processor 1210 may obtain a plurality of module codes included in the module 2110 from the volatile memory device 1300 and execute the plurality of module codes. The processor 1210 may transmit a result of executing the plurality of module codes included in module 2110 to the host 2000. In some example embodiments, the processor 1210 may execute a first module code MODULE CODE1 to a tenth module code MODULE CODE10 included in module 2110.

In some example embodiments, the processor 1210 may obtain a symbol code SYMBOL CODE from the plurality of module codes included in the module 2110 and execute the symbol code SYMBOL CODE. The symbol code SYMBOL CODE may be a code that requests execution of the API included in the main firmware 1310. The processor 1210 may transmit an API request REQ API requesting an API corresponding to the symbol code to the symbol resolution module 1220 in response to the execution of the symbol code SYMBOL CODE.

For example, the processor 1210 may obtain a second module code MODULE CODE2 included in the module 2110 from the volatile memory device 1300 and execute the second module code MODULE CODE2. In some example embodiments, the second module code MODULE CODE2 may be a symbol code that requests execution of the first API API1 included in the main firmware 1310.

The processor 1210 may transmit an API request REQ API requesting execution of the first API API1 corresponding to the second module code MODULE CODE2 to the symbol resolution module 1220 in response to the execution of the second module code MODULE CODE2, which is a symbol code.

As another example, the processor 1210 may obtain the tenth module code MODULE CODE10 included in module 2110 from the volatile memory device 1300 and execute the tenth module code MODULE CODE10. In some example embodiments, the tenth module code MODULE CODE10 may be a symbol code that requests execution of the second API API2 included in the main firmware 1310.

The processor 1210 may transmit the API request REQ API requesting execution of the second API API2 corresponding to the tenth module code to the symbol resolution module 1220 in response to the execution of the tenth module code MODULE CODE10, which is a symbol code.

In some example embodiments, the symbol resolution module 1220 may obtain API access information 1320 stored in the volatile memory device 1300 in response to the API request REQ API and execute an API corresponding to the symbol code based on the API access information 1320.

Specifically, the symbol resolution module 1220 may obtain access information API ACCESS of the API corresponding to the symbol code from the API access information 1320. The symbol resolution module 1220 may obtain the API corresponding to the symbol code among the APIs included in the main firmware 1310 when the access information API ACCESS of the API corresponding to the symbol code includes the access allowance information ALLOW.

The symbol resolution module 1220 may obtain the API corresponding to the symbol code based on the API address map data 1330. The API address map data 1330 may include an address where the API corresponding to the symbol code is stored. The symbol resolution module 1220 may obtain the API corresponding to the symbol code from the main firmware 1310 based on an address API ADDR of the API corresponding to the symbol code.

The symbol resolution module 1220 may execute an API corresponding to the symbol code obtained from the volatile memory device 1300. The symbol resolution module 1220 may transmit a response RESPONSE indicating a result of executing the API corresponding to the symbol code to the processor 1210.

The symbol resolution module 1220 may prohibit execution of the API corresponding to the symbol code when the access information API ACCESS of the API corresponding to the symbol code includes the access prohibition information INHIBIT. The symbol resolution module 1220 may transmit the response RESPONSE indicating that the execution of the API corresponding to the symbol code has failed to the processor 1210.

For example, the symbol resolution module 1220 may receive an API request REQ API from the processor 1210 that requests execution of the first API API1 corresponding to the second module code, which is a symbol code. The symbol resolution module 1220 may obtain access information of the first API corresponding to the second module code from the API access information 1320 stored in the volatile memory device 1300. The access information of the first API may include the access allowance information ALLOW, which allows execution of the first API.

The symbol resolution module 1220 may obtain the first address ADDR1 indicating the address where the first API is stored from the API address map data 1330 stored in the volatile memory device 1300. The symbol resolution module 1220 may obtain the first API API1 stored in the first address ADDR1 among the APIs included in the main firmware 1310 based on the API address map data 1330. The symbol resolution module 1220 may execute first API API1 and transmit a response RESPONSE indicating the result of executing first API API1 to processor 1210. The processor 1210 may transmit the result of executing first API API1 to the host 2000.

As another example, the symbol resolution module 1220 may receive an API request REQ API from the processor 1210 requesting execution of the second API API2 corresponding to the tenth module code, which is a symbol code. The symbol resolution module 1220 may obtain access information of the second API corresponding to the tenth module code from the API access information 1320 stored in the volatile memory device 1300. The access information of the second API may include access prohibition information INHIBIT, which prohibits execution of the second API API2.

The symbol resolution module 1220 may prohibit execution of the second API API2 based on the access information of the second API including the access prohibition information INHIBIT. The symbol resolution module 1220 may transmit a response RESPONSE indicating that the execution of second API API2 has failed to the processor 1210. The processor 1210 may transmit a result RESULT to the host 2000 according to the second API API2 not being executed.

In some example embodiments, the storage device 1000 may load a module received from the host 2000 into the volatile memory device 1300 and execute the loaded module 2110. While executing the module 2110, the storage device 1000 may only execute allowed APIs among the APIs included in the main firmware 1310 based on the API access information 1320.

FIG. 8 is provided for description of a storage device performing a code patch operation according to some example embodiments.

Referring to FIG. 8, a storage device 1000 may include a storage controller 1200 and a volatile memory device 1300. The storage controller 1200 may include a processor 1210 and a symbol resolution module 1220. The volatile memory device 1300 may store main firmware 1310, a patch flag 1340, and a module 2110.

In some example embodiments, the processor 1210 may receive a module from the host 2000. The processor 1210 may verify the manufacturer signature and the first user signature included in the module in response to the module loading request REQ LOAD received from the host 2000, and may control loading of the module to the volatile memory device 1300 based on results of verifying the manufacturer signature and the first user signature.

In some example embodiments, the storage controller 1200 may perform a code patch operation that modifies a main code corresponding to a target address TARGET ADDR included in the module 2110 among the plurality of main codes included in the main firmware 1310. The patch operation may modify the main code included in the main firmware to a code executing a patch code included in the module. The main code included in the main firmware may be modified based on the operation mode information included in the module 2110 to the module.

Specifically, the processor 1210 may identify the operation mode information included in the module 2110. In some example embodiments, the module 2110 may include patch mode information, a target address TARGET ADDR, and a patch code. The target address TARGET ADDR may be an address indicating a position where a code to be modified is stored among the plurality of main codes included in the main firmware 1310.

When the operation mode information includes patch mode information, the processor 1210 may transmit a code patch request REQ PATCH requesting modification of the main code included in the main firmware 1310 to the symbol resolution module 1220. In some example embodiments, the symbol resolution module 1220 may set a patch flag 1340 indicating that a code patch operation is being performed in response to the code patch request REQ PATCH.

The symbol resolution module 1220 may obtain a target address TARGET ADDR from the module 2110 stored in the volatile memory device 1300 in response to the code patch request REQ PATCH. The target address TARGET ADDR may correspond to an address where a code to be modified is stored among the plurality of main codes included in the main firmware.

The symbol resolution module 1220 may transmit a command CMD for reading a main code stored in the target address TARGET ADDR and the target address TARGET ADDR to the volatile memory device 1300. The volatile memory device 1300 may transmit the main code corresponding to the target address among the plurality of main codes included in the main firmware 1310 to the symbol resolution module 1220 in response to the command CMD.

In some example embodiments, among the plurality of the main codes included in main firmware 1310, the main code corresponding to the target address may be a first main code MAIN CODE1. The volatile memory device 1300 may transmit the first main code MAIN CODE1 corresponding to the target address to the symbol resolution module 1220.

The symbol resolution module 1220 may modify the main code corresponding to the target address into a code that executes a patch code PATCH CODE. In some example embodiments, the symbol resolution module 1220 may modify the main code corresponding to the target address to point to a loading address indicating a position where the patch code PATCH CODE is loaded. When the main code corresponding to the target address is modified, the modified code is executed, and then the patch code PATCH CODE may be executed according to the modified code.

In some example embodiments, the symbol resolution module 1220 may modify the first main code MAIN CODE1 received from the volatile memory device 1300 into a first modified code MODIFIED CODE1, which is a code that executes the patch code. The symbol resolution module 1220 may transmit a command CMD for storing the first modified code MODIFIED CODE1, a target address ADDR, and the first modified code MODIFIED CODE1 to the volatile memory device 1300. The volatile memory device 1300 may store the first modified code MODIFIED CODE1 in the target address TARGET ADDR responding to the command CMD.

The symbol resolution module 1220 may clear the patch flag 1340 after changing the first main code MAIN CODE1 included in main firmware 1310 to the first modified code MODIFIED CODE1.

In some example embodiments, after the code patch operation is performed, the processor 1210 may execute the first modified code MODIFIED CODE1 when executing the main firmware 1310, and may execute the patch code PATCH CODE according to the first modified code MODIFIED CODE1, and execute the second main code MAIN CODE2.

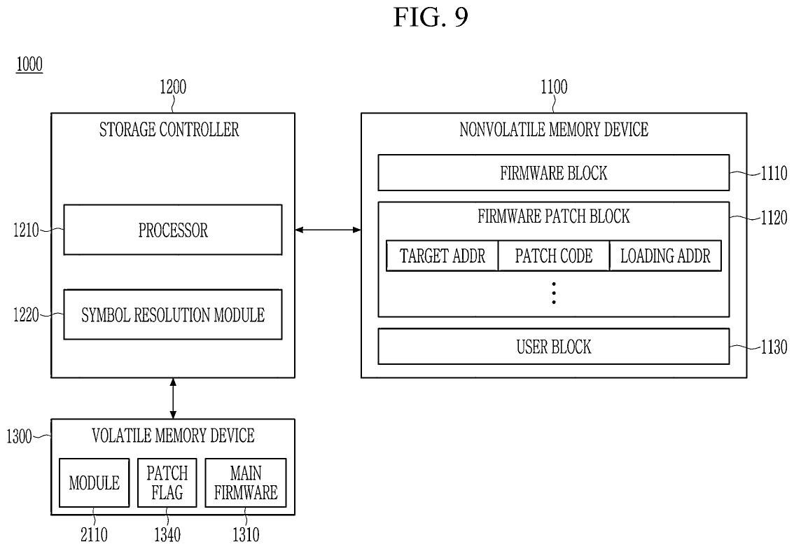

FIG. 9 is provided for description of a storage device storing patch data to a non-volatile memory device according to some example embodiments.

Referring to FIG. 9, a storage device 1000 may include a non-volatile memory device 1100, a storage controller 1200, and a volatile memory device 1300.

In some example embodiments, the non-volatile memory device 1100 may include a firmware block 1110, a firmware patch block 1120, and a user block 1130. The firmware block 1110 may store main firmware. The firmware patch block 1120 may store patch data including a target address TARGET ADDR, a patch code, a loading address LOADING ADDR. The target address TARGET ADDR may be an address indicating a position where a code to be modified according to the code patch operation is stored in the volatile memory device 1300. The loading address LOADING ADDR may be an address indicating a position where the patch code is loaded into the volatile memory device 1300.

In some example embodiments, the symbol resolution module 1220 may perform a code patch operation to modify a code corresponding to the target address among the plurality of main codes included in the main firmware into a code that executes the patch code, and then clear the patch flag.

The symbol resolution module 1220 may transmit patch data including the target address TARGET ADDR, the patch code, and the loading address LOADING ADDR, and a command CMD for storing the patch data to the non-volatile memory device 1100. The non-volatile memory device 1100 may store the patch data in the firmware patch block 1120 in response to the command CMD.

In some example embodiments, when the storage device 1000 is turned off and then turned on after the patch data is stored in the firmware patch block 1120, the storage controller 1200 may control the main firmware stored in the firmware block 1110 and the patch data stored in the firmware patch block 1120 to be loaded to the volatile memory device 1300. In some example embodiments, a main code corresponding to the target address may be loaded to the target address TARGET ADDR of the volatile memory device 1300, and the patch code may be loaded to the loading address LOADING ADDR of the volatile memory device 1300.

The storage controller 1200 may modify the main code corresponding to the target address among the plurality of main codes included in the main firmware 1310 into a code that executes the patch code, based on the target address included in the patch data. The storage controller 1200 may execute the patch code according to the modified code when executing the main firmware 1310.

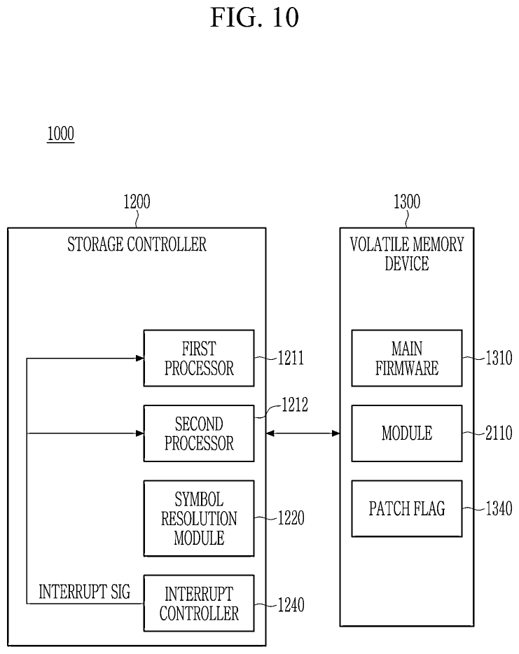

FIG. 10 is provided for description of a storage device that transmits an interrupt signal during operation of a code patch operation according to some example embodiments.

Referring to FIG. 10, a storage device 1000 may include a storage controller 1200 and a volatile memory device 1300.

In some example embodiments, the storage controller 1200 may include a plurality of processors. In some example embodiments, the storage controller 1200 may include a first processor 1211, a second processor 1212, a symbol resolution module 1220, and an interrupt controller 1240.

In some example embodiments, the first processor 1211 may execute the main firmware 1310 loaded on the volatile memory device 1300. The second processor 1212 may execute the module 2110 loaded on the volatile memory device 1300. The module 2110 may be loaded into the volatile memory device 1300 based on a result of verifying the manufacturer signature and the first user signature included in the module 2110.

In some example embodiments, the symbol resolution module 1220 may perform a code patch operation to modify a code corresponding to the target address included in the main firmware 1310 among the plurality of main codes included in the main firmware 1310 based on the patch mode information included in the module 2110. The symbol resolution module 1220 may set the patch flag 1340 during the code patch operation.

The interrupt controller 1240 may transmit an interrupt signal INTERRUPT SIG to the first processor 1211 and the second processor 1212 based on the predetermined patch flag 1340. The first processor 1211 and the second processor 1212 may stop execution of the main firmware 1310 and the module 2110 in response to the interrupt signal INTERRUPT SIG. The first processor 1211 and the second processor 1212 may wait without performing any operation until the patch flag 1340 is cleared.

The symbol resolution module 1220 may clear the patch flag 1340 after performing the code patch operation. The first processor 1211 and the second processor 1212 may execute the main firmware 1310 and the module 2110 based on the cleared patch flag 1340.

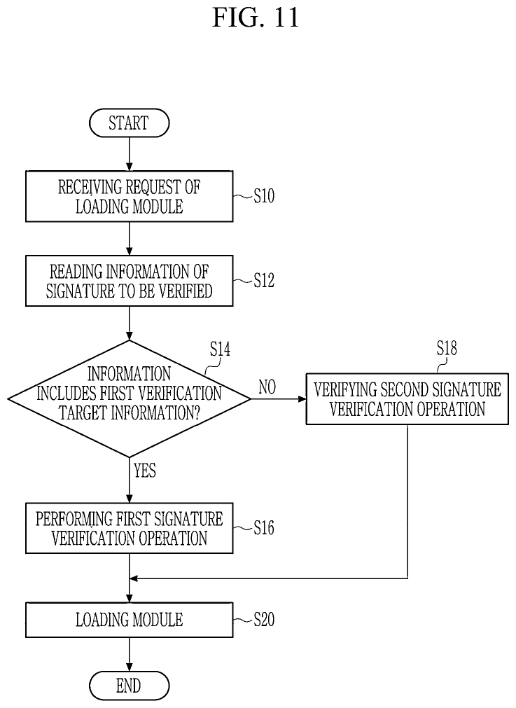

FIG. 11 is a flowchart for description of a storage device that performs a signature verification operation based on information related to a signature to be verified according to some example embodiments.

Referring to FIG. 11, in S10, a storage device 1000 may receive a module loading request. The module loading request may be a request instructing the storage device 1000 to load a module generated in the host 2000 into the volatile memory device 1300 of the storage device 1000.

In S12, the storage device 1000 may read information related to a signature to be verified. In some example embodiments, information of the signature to be verified may be stored in the OTP memory 1230. The information of the signature to be verified may include first verification target information or second verification target information. The information of the signature to be verified may be changed from the first verification target information to the second verification target information by a verification information update request received from the host 2000.

In S14, the storage device 1000 may identify whether the information of the signature to be verified includes the first verification target information. In some example embodiments, if the information of the signature to be verified includes the first verification target information, S16 may be performed. In some example embodiments, if the information of the signature to be verified includes the second verification target information, S18 may be performed.

In S16, the storage device 1000 may perform a first signature verification operation when the information of the signature to be verified includes the first verification target information. The first signature verification operation may be an operation that verifies the manufacturer signature included in the module.

In S18, when the information of the signature to be verified includes the second verification target information, the storage device 1000 may perform a second signature verification operation. The second signature verification operation may be an operation that verifies the manufacturer signature and the first user signature included in the module.

In S20, the storage device 1000 may load a module based on a result of performing the first signature verification operation or the second signature verification operation. The storage device 1000 may load the module into the volatile memory device 1300 if the first or second signature verification operation passes.

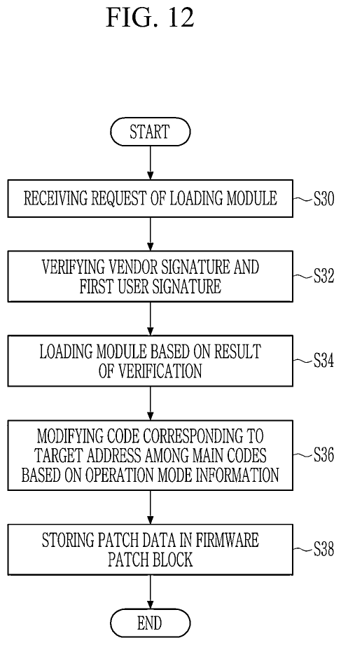

FIG. 12 is a flowchart for description of a storage device performing a code patch operation according to some example embodiments.

Referring to FIG. 12, in S30, the storage device 1000 may receive a module loading request.

In S32, the storage device 1000 may verify the manufacturer signature and the first user signature included in the module. When verifying the manufacturer signature, the storage device 1000 may compare the data of the manufacturer signature decoded with the manufacturer's public key and the module data included in the module. When verifying the first user signature, the storage device 1000 may compare data of the first user signature decoded with the user's public key and the module data and the manufacturer signature included in the module.

In S34, the storage device 1000 may load the module based on the verification result. The storage device 1000 may load the module into the volatile memory device 1300 if verification of the manufacturer signature and the first user signature passes.

In S36, the storage device 1000 may modify a code corresponding to the target address among the plurality of main codes included in the firmware based on the operation mode information included in the module. The operation mode information included in the module may include patch mode information that modifies the main code included in the firmware.

In S38, the storage device 1000 may store patch data in the firmware patch block. The patch data may include a target address indicating a position where a code to be modified is stored in the volatile memory device, patch data, and a loading address indicating a position where the patch code is loaded in the volatile memory device.

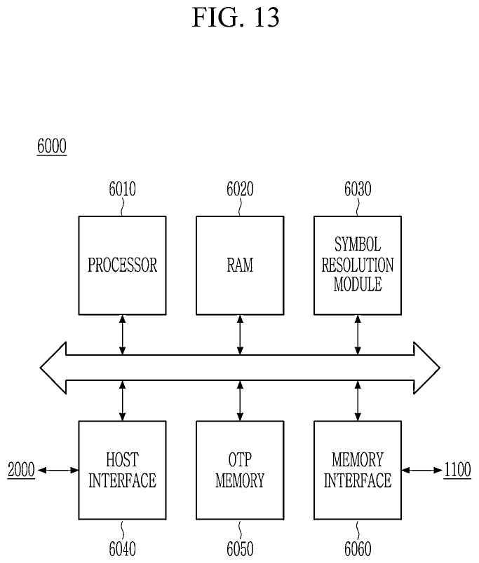

FIG. 13 is provided for description of a configuration of a storage controller according to some example embodiments.

Referring to FIG. 13, a storage controller 6000 may include a processor 6010, a RAM 6020, a symbol resolution module 6030, a host interface 6040, an OTP memory 6050, and a memory interface 6060.

The processor 6010 may control the overall operation of the storage controller 6000. The processor 6010 may control the operation of the storage controller 6000 to store data received from the host 2000 in the non-volatile memory device 1100. In some example embodiments, the processor 6010 may control loading of the module into the RAM 6020 based on the result of verifying the module received from the host. In some example embodiments, the processor 6010 may execute main firmware and modules. In some example embodiments, the processor 6010 may be provided in plurality.

The RAM 6020 may be used as a buffer memory, a cache memory, and/or an operation memory of the storage controller 6000. In some example embodiments, the RAM 6020 may temporarily store main firmware and modules. In some example embodiments, the RAM 6020 may temporarily store API access information and API address map data.

The symbol resolution module 6030 may obtain an API corresponding to the symbol code based on the API access information from among the plurality of APIs included in the main firmware. The symbol resolution module 6030 may obtain the API corresponding to the symbol code from the RAM 6020 based on the API address map data. The symbol resolution module 6030 may perform a code patch operation that modifies a code corresponding to the target address among the plurality of main codes included in the main firmware into a code that executes the patch code, based on the operation mode information included in the module.

The storage controller 6000 may communicate with the host 2000 through the host interface 6040. The storage controller 6000 may receive data through the host interface 6040. In some example embodiments, the host interface 6040 may receive a module from the host 2000.

The OTP memory 6050 may store information of a signature to be verified. The information of the signature to be verified may include first verification target information or second verification target information. The first verification target information may correspond to a first signature verification operation that verifies the manufacturer signature included in the module. The second verification target information may correspond to a second signature verification operation that verifies the manufacturer signature and the first user signature included in the module.

The storage controller 6000 may communicate with the non-volatile memory device 1100 through the memory interface 6060. The storage controller 6000 may provide a command, an address, and data to the non-volatile memory device 1100 through the memory interface 6060. In some example embodiments, the storage controller 6000 may provide patch data including a target address, a patch code, and a loading address to the non-volatile memory device 1100 through the memory interface 6060.

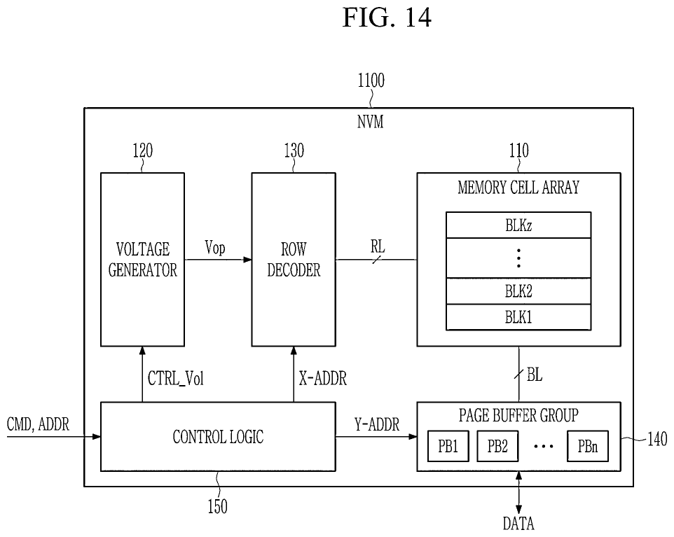

FIG. 14 is provided for description of a configuration of a non-volatile memory device according to some example embodiments.

Referring to FIG. 14, a non-volatile memory device 1100 may include a memory cell array 110, a voltage generator 120, a row decoder 130, a page buffer group 140, and a control logic 150.

The memory cell array 110 may include a plurality of memory blocks BLK1 to BLKz. The plurality of memory blocks BLK1 to BLKz may be connected with the row decoder 130 through row lines RL. The plurality of memory blocks BLK1 to BLKz may be connected with the page buffer group 140 through bit lines BL. In some example embodiments, the plurality of memory blocks BLK1 to BLKz may include a firmware block, a firmware patch block, and/or a user block.

Each of the plurality of memory block BLK1 to BLKz may include a plurality of memory cells. In some example embodiments, the plurality of memory cells may be non-volatile memory cells.

The voltage generator 120 may generate operating voltages Vop using an external power source voltage supplied to the non-volatile memory device 1100. The voltage generator 120 may operate in response to the control of the control logic 150.

In some example embodiments, the voltage generator 120 may generate the operating voltages Vop used in program operations, read operations, and erase operations. For example, the voltage generator 120 may generate an erase voltage, a program voltage, a pass voltage, a read voltage, and/or an erase voltage. The operating voltages Vop may be supplied to the memory cell array 110 by the row decoder 130.

The row decoder 130 may be connected to the memory cell array 110 through row lines RL. The row lines RL may include drain selection lines, word lines, and source selection lines.

The row decoder 130 may be configured to operate in response to the control of the control logic 150. The row decoder 130 may receive a row address X-ADDR from the control logic 150. In some example embodiments, the row decoder 130 may select at least one word line among the plurality of word lines based on the row address X-ADDR, and may apply the operating voltages Vop provided from the voltage generator 120 to at least one word line.

In some example embodiments, the row decoder 130 may apply a program voltage to a selected word line among the plurality of word lines and apply a pass voltage at a level lower than the program voltage to the unselected word lines during a program operation. When performing a program verification operation, the row decoder 130 may apply a verification voltage to the selected word line and a verification pass voltage at a level higher than the verification voltage to the unselected word lines.

During a read operation, the row decoder 130 may apply a read voltage to the selected word line and a read pass voltage at a level higher than the read voltage to the unselected word lines.

The page buffer group 140 may include a plurality of page buffers PB1 to PBn. The plurality of page buffers PB1 to PBn may be respectively connected to the memory cell array 110 through the bit lines BL. The plurality of page buffers PB1 to PBn may operate in response to the control of the control logic 150.

In some example embodiments, the plurality of page buffers PB1 to PBn may receive data DATA from the outside. The plurality of page buffers PB1 to PBn may select at least one bit line among the bit lines BL based on a column address Y-ADDR received from the control logic 150.

In some example embodiments, the plurality of page buffers PB1 to PBn may transmit data received from the outside to the memory cells of the memory cell array 110 through the bit lines BL during the program operation. The memory cells may be programmed according to the received data. The plurality of page buffers PB1 to PBn may sense data stored in the memory cells through the bit lines BL during the program verification operation.

During the read operation, the plurality of page buffers PB1 to PBn may sense data stored in the memory cells through the bit lines BL and store the sensed data in the plurality of page buffers PB1 to PBn.

The control logic 150 may be connected to the voltage generator 120, the row decoder 130, and the page buffer group 140. The control logic 150 may be configured to control overall operations of the non-volatile memory device 1100. The control logic 150 may operate in response to a command CMD transmitted from the outside. The control logic 150 may control the voltage generator 120, the row decoder 130, and the page buffer group 140 by generating various signals in response to the command CMD and the address ADDR.

Any or all of the elements described with reference to the figures may communicate with any or all other elements described with reference to the respective figures. For example, any element may engage in one-way and/or two-way and/or broadcast communication with any or all other elements, to transfer and/or exchange and/or receive information such as but not limited to data and/or commands, in a manner such as in a serial and/or parallel manner, via a bus such as a wireless and/or a wired bus (not illustrated). The information may be in encoded various formats, such as in an analog format and/or in a digital format.

Any of the elements and/or functional blocks disclosed above may include or be implemented in processing circuitry such as hardware including logic circuits; a hardware/software combination such as a processor executing software; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc. The processing circuitry may include electrical components such as at least one of transistors, resistors, capacitors, etc. The processing circuitry may include electrical components such as logic gates including at least one of AND gates, OR gates, NAND gates, NOT gates, etc.

Although some example embodiments of the present disclosure have been described in detail above, the scope of the present disclosure is not limited to this, and several variations implemented by a person of an ordinary skill in the art using the basic concepts of the present disclosure defined in the following claim range also fall within the scope of the present inventive concepts.

What is claimed is:

1. A storage device comprising:
a volatile memory device configured to load main firmware; and
a storage controller configured to,
receive a module loading request and a module from outside the storage device,
perform a first signature verification operation verifying a first signature included in the module or a second signature verification operation verifying the first signature and a second signature included in the module based on information on a signature to be verified, and
load the module received from outside the storage device to the volatile memory device based on a result of performing the first signature verification operation or the second signature verification operation.

2. The storage device of claim 1, wherein
the storage controller includes a one-time programmable (OTP) memory configured to store information of the signature to be verified, and
the information of the signature to be verified contains first verification target information corresponding to the first signature verification operation.

3. The storage device of claim 2, wherein
the storage controller is configured to receive a verification information update request from outside the storage device and update the first verification target information stored in the OTP memory with second verification target information corresponding to the second signature verification operation in response to the verification information update request.

4. The storage device of claim 1, wherein
the storage controller is configured to:
transmit a first nonce to outside the storage device in response to the module loading request,
receive a third signature by signing the first nonce with a private key of a user, and
compare the first nonce with a second nonce generated by decoding the third signature with a public key of the user.

5. The storage device of claim 1, wherein
the first signature is a manufacturer signature in which module data included in the module are signed with a private key of a manufacturer, and
the storage controller is configured to verify the manufacturer signature based on a result of comparing data obtained from decoding the manufacturer signature with a public key of the manufacturer and the module data included in the module.

6. The storage device of claim 1, wherein
the second signature is a user signature in which module data and the first signature included in the module are signed with a private key of a user, and
the storage controller is configured to verify the user signature based on a result of comparing data obtained from decoding the user signature with a public key of the user with the module data and the first signature included in the module.

7. The storage device of claim 1, wherein the storage controller is configured to:
obtain a decryption key in which an encryption key included in the module is decoded by a private key of a manufacturer, and
control the volatile memory device to load a code in which a module code included in the module is decoded by the decryption key to the volatile memory device.

8. The storage device of claim 1, wherein
the storage controller includes a symbol resolution module configured to generate application programming interface (API) access information indicating whether access to APIs included in the main firmware is allowed based on API information included in the module.

9. The storage device of claim 8, wherein
the storage controller includes a processor configured to execute module codes included in the module in response to a module execution request received from outside the storage device, the processor configured to transmit an API request that requests an API corresponding to a symbol code among the module codes in response to execution of the symbol code to the symbol resolution module.

10. The storage device of claim 9, wherein the symbol resolution module is configured to obtain an API corresponding to the symbol code among the APIs included in the main firmware based on the API access information in response to the API request, the symbol resolution module configured to provide a result of execution of the API corresponding to the symbol code.

11. The storage device of claim 1, wherein
the storage controller is configured to modify a code corresponding to a target address included in the module among main codes included in the main firmware into a code that executes a patch code included in the module based on the target address,
the storage controller configured to modify the code in response to operation mode information included in the module including patch mode information.

12. A storage device comprising:
a volatile memory device configured to load main firmware including main codes; and
a storage controller configured to:
receive a module from outside the storage device,
load the module to the volatile memory device based on a result of verifying a manufacturer signature and a user signature included in the module, and
modify a code corresponding to a target address included in the module among the main codes based on operation mode information included in the module.

13. The storage device of claim 12, wherein
the storage controller is configured to verify the manufacturer signature based on a result of comparing data obtained from decoding the manufacturer signature with a public key of a manufacturer with module data included in the module.

14. The storage device of claim 12, wherein
the storage controller is configured to verify the user signature based on a result of comparing data obtained from decoding the user signature with a public key of a user with module data included in the module.

15. The storage device of claim 12, wherein
the operation mode information includes patch mode information, and
the storage controller is configured to modify a code corresponding to the target address to a code executing a patch code included in the module.

16. The storage device of claim 15, further comprising:
a non-volatile memory device including a firmware patch block,
wherein the storage controller is configured to control the non-volatile memory device to store patch data including the target address, a loading address where the patch code is loaded, and the patch code into the firmware patch block.

17. A storage controller comprising:
a first processor configured to execute main firmware;
a second processor configured to,
verify a manufacturer signature in which module data included in an externally received module are signed with a private key of a manufacturer, and
execute the module based on a result of verifying a user signature in which the module data and the manufacturer signature are signed with a private key of a user; and
a symbol resolution module configured to perform a code patch operation modifying a code corresponding to a target address included in the module among main codes included in the main firmware based on the target address.

18. The storage controller of claim 17, wherein
the symbol resolution module is configured to set a patch flag indicating that a patch operation is being performed.

19. The storage controller of claim 18, further comprising:
an interrupt controller configured to transmit an interrupt signal to the first processor and the second processor based on the patch flag.

20. The storage controller of claim 17, wherein
the second processor is configured to execute a patch code included in the module according to the code corresponding to the target address in response to the code patch operation being performed.
